(19) United States
(12) Patent Application Publication
(10) Pub. No.: US 2026/0319595 A1
(43) Pub. Date: Oct. 15, 2026

(54) METHOD OF CORRECTING AZIMUTHAL DRIFT ARISING IN AN INERTIAL MEASUREMENT UNIT, AND A DEVICE AND SYSTEM THEREFOR

(71) Applicant: Sony Interactive Entertainment Inc., Tokyo (JP)

(72) Inventors: Calum Armstrong, London (GB); Christopher George Buchanan, London (GB); Michael Lee Jones, London (GB); Naoise Tobin, London (GB); Alexei Ashton Derek Smith, Bristol (GB)

(21) Appl. No.: 19/467,189

(22) Filed: Feb. 2, 2026

(30) Foreign Application Priority Data
Feb. 7, 2025 (GB) 2501865.6

(51) Int. Cl. G06F 3/0346; G01B 11/26; G01P 15/08; G06F 3/01; G06F 3/03; G06T 11/00; H04R 1/10

(52) U.S. Cl. CPC G06F 3/0346; G01B 11/26; G01P 15/08; G06F 3/014; G06F 3/0304; G06T 11/00; H04R 1/1041

(57) ABSTRACT

A method of correcting azimuthal drift arising in an inertial measurement unit, IMU, of a peripheral device operable by a user, including : obtaining, from the IMU, an azimuthal angle of the peripheral device; receiving a signal from a sensor, the signal being generated by the sensor in response to user interaction with the media content; in response to receiving the signal, determining whether a value of the azimuthal angle falls within a predetermined range; and adjusting the azimuthal angle to a predetermined value if the value falls within the predetermined range.

### CROSS-REFERENCE TO RELATED APPLICATIONS

This application claims priority to United Kingdom Application No. 2501865.6, filed on Feb. 7, 2025, the contents of which are incorporated herein by reference.

### FIELD OF THE INVENTION

The present invention relates to the field of motion sensors, and in particular to a method of correcting azimuthal drift arising in an inertial measurement unit, IMU, of a peripheral device operable by a user; and a device and system therefore.

### BACKGROUND

Inertial measurement units (also known as IMUs) typically comprise accelerometers, gyroscopes and/or magnetometers, and are typically used to track the position and/or motion of the device to/within which they are coupled/integrated. In the context of video gaming, IMUs may be coupled to/integrated within peripheral devices such as game controllers, head-mounted displays, and the like. The tracked position and/or motion of these peripheral devices during a video game session may be used to enhance a user’s interaction with the video game — the tracked motion of a controller may be used to steer an in-game vehicle, for example. In the context of sound systems, IMUs may be coupled to/integrated within wearable audio systems such as (bone conduction) headphones, earphones, and the like. The tracked position and/or motion of these wearable audio systems during audio playback (of music, film audio, video game audio, and the like) may be used to provide a more immersive listening experience — the tracked motion of headphones may be used to provide sound localisation effects whereby users perceive certain parts of the audio as coming from fixed positions relative to themselves, regardless of their head orientation.

IMUs typically perform rotational position and/or motion tracking in three rotational axes: roll, pitch (also known as elevation) and yaw (also known as azimuth). A common issue affecting the accuracy of position and/or motion tracking is drift. Drift is typically manifest as a discrepancy between the device’s position/motion measured by the IMU and the device’s actual position/motion. For example, drift may cause an IMU to measure a non-zero acceleration of the device when the device is in fact stationary. As another example, drift may cause an IMU to measure an angular displacement of the device (relative to a datum orientation) to be non-zero when the device is in fact in the datum orientation. It will be appreciated that the latter angular drift may even be caused by the former acceleration drift, as acceleration measurements are typically numerically integrated to obtain angular displacement measurements.

In terms of rotational position and/or motion tracking, drift typically occurs about the yaw (azimuth) axis, as unlike the roll and pitch axes, rotations about the yaw axis are independent of gravitational effects.

As an example, when a rotation about the roll or pitch axis occurs, the IMU measures the total acceleration of the device, that is, the acceleration due to gravity (arising due to gravitational forces exerted on the IMU/device) in addition to whatever roll-wise or pitch-wise acceleration the IMU/device is undergoing due to other external forces acting on it (such as mechanical forces from a user pushing/pulling/manipulating the device). Therefore, when the roll or pitch rotation ceases, the IMU measures the acceleration due to gravity only. Thus, the gravitational forces exerted on the IMU/device act as an anchor for the IMU’s measurements. That is, these gravitational forces provide a de facto reference acceleration value with respect to which any roll-wise or pitch-wise acceleration of the IMU/device is measured by the IMU.

However, given that yaw-wise (azimuthal) motion occurs in a plane perpendicular to the direction of gravitational forces, the gravitational forces cannot provide a similar anchoring effect for IMU in respect of any azimuthal accelerations. Thus, drift may still occur in the azimuthal direction.

A known method of providing an azimuthal anchor for IMUs is to provide an external magnetic field. At least a component of the resulting magnetic attraction force provided by this external magnetic field acts in a direction parallel to the plane in which azimuthal motion occurs. As a result, the magnetometers of the IMU (if present) may measure the (rate of change in) direction of IMU relative to the source of the external magnetic field, and thereby provide accurate azimuthal acceleration, velocity and position measurements.

However, external magnetic fields may negatively impact the functioning of the entertainment device (games console, computer, audio system, TV, or the like) executing the media (video game, film, music, or the like) with which the user is interacting (via IMU-enabled peripheral devices or wearable audio systems). Thus, even though the external magnetic field may provide more accurate azimuthal tracking by the IMU of the peripheral device/wearable audio system (and so more accurate sound localisation and/or control signals for controlling interaction with the content), this same external magnetic field may also cause the entertainment device to output the media at a poorer quality (the video/audio signal is noisier, for example), or even prevent the entertainment device from outputting media at all (due to a malfunction in its internal circuitry, for example).

The present disclosure seeks to alleviate or mitigate this issue.

### SUMMARY

In a first aspect, there is provided a method of correcting azimuthal drift arising in an inertial measurement unit, IMU, of a peripheral device operable by a user, including the steps of: obtaining, from the IMU, an azimuthal angle of the peripheral device; receiving a signal from a sensor, the signal being generated by the sensor in response to user interaction with the media content; in response to receiving the signal, determining whether a value of the azimuthal angle falls within a predetermined range; and adjusting the azimuthal angle to a predetermined value if the value falls within the predetermined range.

Optionally, the peripheral device includes a head-wearable audio system. Further optionally, the head-wearable audio system is one of: a pair of headphones; a pair of bone conduction headphones; and a pair of earphones.

Optionally, the sensor is an input mechanism of an input device for providing control signals to control the media content. Further optionally, the input device is one of: a remote control device; a video game controller; a mouse; a keyboard; a smartphone; a laptop or tablet computer; and a portable video game console.

Optionally, the sensor comprises a light sensing element wearable on the head of the user and configured such that, when in use, the light sensing element senses light from a screen outputting the media content when the face of the user is oriented towards the screen. Further optionally, the light sensing element is coupled to the head-wearable audio system. Further optionally, the lighting sensing element comprises one or more of: a photodiode; and a camera.

Optionally, the method includes the step of evaluating whether the signal satisfies one or more illumination criteria, wherein the step of determining whether the azimuthal angle falls within a predetermined range is carried out if the signal satisfies one or more of the illumination criteria. Further optionally, the one or more illumination criteria include one or more of: a light color; a light intensity; a change in light color; a change in light intensity; and a frequency range or wavelength range of the light.

Optionally, the method includes the steps of: rendering image frames of the media content; inserting a calibration frame after every N image frames of the media content have been rendered, wherein N ≥ 1, wherein each inserted calibration frame includes predetermined image data for satisfying one or more of the illumination criteria; and outputting the media content having the inserted calibration frames.

Optionally, the peripheral device includes an input device for providing control signals to control the media content. Further optionally, the sensor is an input mechanism of the input device.

Optionally, the sensor includes a light sensing element wearable on the hand of the user or coupled to the input device and configured such that, when in use, the light sensing element senses light from a screen outputting the media content when the input device is oriented towards a predefined orientation relative to the screen.

Optionally, the method includes the step of evaluating whether the signal satisfies one or more illumination criteria, wherein the step of determining whether the azimuthal angle falls within a predetermined range is carried out if the signal satisfies one or more of the illumination criteria. Examples of illumination criteria were provided earlier herein.

Optionally, the method includes the steps of: rendering image frames of the media content; inserting a calibration frame after every N image frames of the media content have been rendered, wherein N ≥ 1, wherein each inserted calibration frame includes predetermined image data for satisfying one or more of the illumination criteria; and outputting the media content having the inserted calibration frames.

Optionally, the step of obtaining an azimuthal angle includes obtaining an azimuthal velocity and/or azimuthal acceleration from the IMU; the step of determining whether the value of the azimuthal angle falls within the predetermined range includes, in response to receiving the signal, determining whether an azimuthal velocity value and/or azimuthal acceleration value falls within a predetermined velocity range and/or a predetermined acceleration range; and the step of adjusting the azimuthal angle is carried out if the azimuthal velocity value and/or azimuthal acceleration value falls within the predetermined velocity range and/or the predetermined acceleration range, respectively.

Optionally, the value of the azimuthal angle, the predetermined range and the predetermined value are all defined with respect to a datum orientation of the peripheral device, and the method includes the steps of: receiving a plurality of signals from the sensor, each signal being generated in response to a respective user interaction with the media content; for each signal that is received, storing a respective instantaneous value of the azimuthal angle, regardless of whether the respective instantaneous value falls within the predetermined range; determining an average value of the azimuthal angle based on the stored respective instantaneous values; and adjusting the datum orientation of the peripheral device based on the average value.

Optionally, the step of storing the respective instantaneous value includes storing the respective capture time at which the respective instantaneous value was measured, and the step of determining the average value comprises: selecting the stored instantaneous values whose respective capture times fall within a predetermined time period, the predetermined time period corresponding to a present real-world time; and determining the average value based on the selected instantaneous values.

Optionally, the obtaining step includes obtaining a time-series data stream of the azimuthal angle of the peripheral device; the method may include the step of storing the obtained time-series data stream; the determining step may include: in response to receiving the signal, selecting a subset of the stored time-series data stream, an endpoint of the subset being a present real-world time, and an average value of the azimuthal angle based on the selected subset; and adjusting step may include adjusting a most-recently obtained value of the azimuthal angle to a predetermined value if the average value falls within the predetermined range.

In a second aspect, there is provided a computer program including processor-implementable instructions which, when executed by a processor, cause the processor to perform the method of the first aspect.

In a third aspect, there is provided a non-transitory computer-readable storage medium having stored thereon the computer program of the second aspect.

In a fourth aspect, there is provided a device including a processor and a memory, the memory having stored thereon processor-implementable instructions which, when executed by the processor, cause the processor to perform the method of the first aspect.

In a fifth aspect, there is provided a system, including: a device according to the fourth aspect, a peripheral device including an inertial measurement unit, IMU; and a sensor configured to generate a signal in response to user interaction with the media content.

Optionally, the system includes an output device for outputting the media content.

### BRIEF DESCRIPTION OF DRAWINGS

Embodiments of the present disclosure will now be described by way of example with reference to the accompanying drawings, in which:

FIG. 1 is a flowchart illustrating a computer-implemented method according to embodiments of the present disclosure ;

FIG. 2 schematically illustrates a device according to embodiments of the present disclosure ; and

FIG. 3 schematically illustrates a system according to embodiments of the present disclosure .

### DETAILED DESCRIPTION

A computer-implemented method of correcting azimuthal drift arising in an inertial measurement unit, IMU, of a peripheral device operable by a user; and a device and system therefor are disclosed. In the following description, a number of specific details are presented in order to provide a thorough understanding of the embodiments of the present disclosure . It will be apparent, however, to a person skilled in the art that these specific details need not be employed to practice the disclosed technology. Conversely, specific details known to the person skilled in the art are omitted for the purposes of clarity where appropriate.

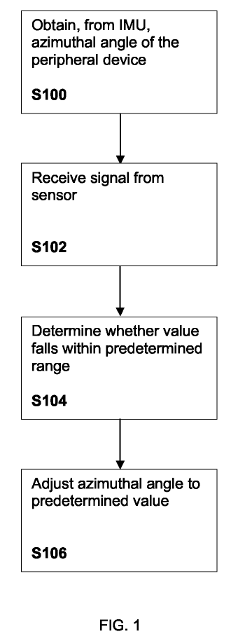

Turning now to FIG. 1, in embodiments of the present disclosure, a (computer-implemented) method of correcting azimuthal drift arising in an inertial measurement unit, IMU, of a peripheral device operable by a user includes the steps of: obtaining, from the IMU, an azimuthal angle of the peripheral device (step S100); receiving a signal from a sensor, the signal being generated by the sensor in response to user interaction with the media content (step S102); in response to receiving the signal, determining whether a value of the azimuthal angle falls within a predetermined range (step S104); and

adjusting the azimuthal angle to a predetermined value if the value falls within the predetermined range (step S106).

This is to say that embodiments of the present disclosure relate to a method of azimuthal drift correction without relying on externally applied forces such as external magnetic fields, but rather on aspects relating to a user’s interaction with the media content (via the IMU-enabled peripheral device/wearable audio system). In response to detecting a user interaction with the media content, the azimuthal angle currently measured by IMU of the peripheral device or wearable audio system — both being referred to as “peripheral device” hereafter — is compared against a predetermined range of values. This predetermined range of values may represent the typical range of azimuthal angle measurements made by the IMU (due to the effect of drift) at a point in time when the peripheral device is assumed/found to be stationary at a predetermined azimuthal angle value (such as a zero-degree angle when the peripheral device is being held in its datum orientation, for example). If the azimuthal angle measurement falls within the predetermined range of values, then it is assumed that the peripheral device is being held in an orientation aligning with the predetermined azimuthal angle value, and so the azimuthal angle measurement is adjusted to that of the predetermined azimuthal angle value. For example, the predetermined range of values may be -3 degrees to +3 degrees with respect to some datum orientation of the peripheral device, and the predetermined azimuthal angle value may be 0 degrees (that is, the datum orientation). When it is found that the 1 degree measurement made by the IMU falls within this range, the measurement is adjusted to 0 degrees. That is, the peripheral device is assumed to actually be held in an orientation aligning with the zero-degree angle defined by the datum orientation, and so the peripheral device’s IMU is zeroed with respect to the datum orientation.

It should be noted that the predetermined azimuthal angle value does not need to coincide with a datum orientation/zero-angle of the peripheral device, but may be beneficial to do so, as the datum orientation may represent the orientation in which the user most frequently/commonly holds/wears their peripheral device. In any case, the predetermined azimuthal angle value may be defined with respect to the datum orientation. It should also be noted that the datum orientation may be any orientation of the peripheral device relative to the entertainment device outputting the media content (a games console, computer, a TV screen, for example). The most commonly-used datum orientation may be a “towards the screen” orientation where the user holds/wears the peripheral device such that the peripheral device’s transceiver unit (a wired/wireless communication port, for example) faces the centre of a screen displaying the media content, and is oriented in a direction perpendicular to the plane of the screen. However, other orientations may be set as the datum orientation. In any case, the datum orientation should be taken to mean an orientation relative to which any angular (azimuthal, for example) displacements of the peripheral device are measured by the IMU. As such, the peripheral device as a zero-degree azimuthal/angular displacement in the case where it is oriented in the datum orientation.

As a first non-limiting example of user interaction, IMU drift correction may be performed in response to a user manipulating a button/trigger/joystick or other input mechanism of the IMU-enabled peripheral device (that is, the peripheral device to/within which the IMU is coupled/integrated) or of a different peripheral device (that is not IMU-enabled or whose IMU is not presently being corrected). In this case, it is assumed that the user will manipulate the input mechanism when they are looking/have oriented the peripheral device towards the entertainment device outputting the media content, and may look/orient the peripheral device in other directions when not manipulating such mechanisms (they may be talking to a friend, looking at their smartphone, or the like).

For example, users typically look at a screen displaying a video game in order to determine what action to take within the video game, and so determine which button/trigger/joystick of the games controller to press/manipulate. If the user is wearing a set of IMU-enabled headphones while playing the game (to experience sound localised game audio), then it may be assumed that the headphones are oriented to align with a “towards the screen” datum orientation when the user presses button/trigger/joystick in response to the game events. Thus, in response to the button/trigger/joystick manipulation by the user, the azimuthal angle currently measured by the headphone’s IMU — which may be affected by drift due to the user looking elsewhere prior to the button/trigger/joystick press — is compared against the predetermined range, and the azimuthal angle is zeroed if the azimuthal angle falls within the predetermined range (-3 to +3 degrees with respect to the datum, for example). A similar procedure may be carried out if the IMU-enabled peripheral device is a games controller — users typically hold their controller in a “towards the screen” datum orientation when providing control signals to control their in-game character, and so in response to controller button/trigger/joystick manipulation by the user, the azimuthal angle measured by that controller’s IMU is zeroed if that azimuthal angle falls within the predetermined range (-3 to +3 degrees with respect to the datum, for example).

As a second non-limiting example of user interaction, additional sensors (other than the input mechanisms of a peripheral device) may be employed to detect whether the user is looking/the peripheral device is oriented towards the entertainment device outputting the media content (that is, whether the user is engaged with the media content). For example, such an additional sensor may be a photodiode, which may be coupled to the IMU-enabled peripheral device. The photodiode may detect light of a certain brightness/color/other illumination characteristic of light emitted by, say, a screen displaying the media content. In this case, when the peripheral device is oriented away from the screen (when the user is talking to a friend or looking at their smartphone, for example), the photodiode may detect light which does not possess the illumination characteristics of the screen displaying media content. However, when the user does look towards the screen, the photodiode detects light possessing the appropriate illumination characteristics, and so triggers the comparison between the IMU’s azimuthal angle measurement and the predetermined range of values. As discussed in the previous non-limiting example, if the azimuthal angle value falls within the predetermined range, the azimuthal angle value is adjusted/zeroed.

In any case, and as will be appreciated, by avoiding the use of external magnetic fields, there is a reduction in the risk of damage to an entertainment device (game console, computer, audio system) and/or the deterioration in the quality of the media content (video games, films, music) output thereby due to electrical interference. Thus, the present disclosure provides a less destructive method of azimuthal drift correction.

### Receiving the Azimuthal Angle

As will be appreciated, in order to correct the azimuthal angle measured by the IMU, the measurements made by the IMU are first obtained.

Therefore, in embodiments of the present disclosure, the method includes the step of obtaining, from the IMU (of a peripheral device), an azimuthal angle of the peripheral device (step S100). Obtaining step S100 may be performed by an input port (such as a USB port, Ethernet ® port, Wi-Fi ® port, Bluetooth ® port, and the like) of an entertainment device (such as a video games console, a computing system, and the like), optionally in conjunction with a processing unit (a CPU, GPU, and the like) of the entertainment device, for example.

As mentioned previously, an IMU (that is, inertial measurement unit) is typically used to track the position and/or motion of the device to which it is coupled. To facilitate this tracking, the IMU typically includes at least one of an accelerometer, a gyroscope and a magnetometer. The IMU may be integral to the to-be-tracked device, or may be attached to the device via some (detachable) coupling mechanism. In any case, as the device moves, the accelerometer, gyroscope and/or magnetometer of the IMU may measure kinematic properties such as the position, velocity (rate of change in position), acceleration (rate of change in velocity), and/or jerk (rate of change of acceleration) of the moving device.

It should be noted that each type of IMU component may be capable of directly measuring a respective (sub)set of kinematic properties. For example, an accelerometer may be capable of directly measuring acceleration, and so to obtain position/velocity, the acceleration measurement data obtained by the accelerometer may be numerically integrated with respect to time. Conversely, to obtain jerk, the acceleration measurement data may be numerically differentiated with respect to time.

As will be appreciated, the IMU may be coupled to/integrated with the to-be-tracked peripheral device, and during use of the peripheral device, this IMU may be used to measure an azimuthal (yaw-wise) angle of the peripheral device with respect to some datum orientation thereof by directly measuring angular kinematic properties (such as azimuthal velocity/acceleration) and performing suitable data processing steps (such as numerical integration/differentiation).

As will be appreciated, peripheral devices are typically devices which facilitate a user’s passive/active interaction with the media content. For example, a pair of headphones may be thought of as a peripheral device, as the user may listen to (that is, passively interact with) the media content’s audio via the headphones. As another example, a games controller may be thought of as a peripheral device, as the user (actively) interacts with a video game (that is, media content) by manipulating the input mechanisms (buttons, triggers, joysticks, and the like) of the games controller.

Therefore, in embodiments of the present disclosure, the peripheral device (with/to which the IMU is integrated/coupled) may optionally include a head-wearable audio system. A “head-wearable audio system” may be thought of as a system which a user wears on/around their head and which is suitable for outputting audio to a user.

Examples of head-wearable audio systems include a pair of headphones, a pair of bone conduction headphones, and a pair of earphones. It will be appreciated that these examples are entirely non-limiting; the skilled person will understand that other types of head-wearable audio systems are also contemplated within the scope of the present disclosure.

Alternatively, in embodiments of the present disclosure, the peripheral device may optionally include an input device for providing control signals to control the media content. Alternatively put, an input device may be thought of as a device via which the user may actively interact with the media content. For example, a games controller may be thought of as a peripheral device, as a user may press a button of the controller to cause some change in the media content (make an in-game character jump, pausing the game/film, and the like).

Examples of input devices include a remote control device (a TV remote, for example), a video game controller, a mouse, a keyboard, a smartphone, a laptop or tablet computer, and a portable video game console. It will be appreciated that these examples are entirely non-limiting; the skilled person will understand that other types of input devices are also contemplated within the scope of the present disclosure.

In any case, the IMU of the peripheral device may transmit measurement data to the input port of the entertainment device via wired or wireless communication methods such as a USB/Ethernet ® cable, or Wi-Fi ®/Bluetooth ® communication. This measurement data may be the azimuthal angle of the peripheral device, and so obtaining step S100 may include receiving the azimuthal angle (at an input port of the entertainment device, for example). Alternatively, this measurement data may be some other angular kinematic property from which the azimuthal angle may be derived. For example, this measurement data may be an azimuthal acceleration and/or an azimuthal velocity. In this case, obtaining step S100 may include receiving measurement data (at an input port of the entertainment device, for example), and determining the azimuthal angle based on the measurement data (by using a processing unit of the entertainment device to numerically integrate/differentiate the measurement data, for example). As will be appreciated, the azimuthal angle may be obtained in the form of a time-series data stream, that is, a continuous flow of data received during playback of the media content, for example.

### Receiving the Interaction-Responsive Signal

As will be appreciated, given that the comparison between the IMU’s measured azimuthal angle and the predetermined range is triggered by a user interaction with the media content, a signal responsive to that user interaction is first obtained.

Therefore, in embodiments of the present disclosure, the method includes the step of receiving a signal from a sensor, the signal being generated by the sensor in response to user interaction with the media content (step S102). Receiving step S102 may be performed by an input port (such as a USB port, Ethernet ® port, Wi-Fi ® port, Bluetooth ® port, and the like) of an entertainment device (such as a video games console, a computing system, and the like), for example.

As mentioned previously, a user manipulating an input mechanism of the to-be tracked peripheral device or of another peripheral device may be used as the user interaction which triggers the comparison between the measured azimuthal angle of the peripheral device and the predetermined range. As mentioned previously, this may be done under the assumption that the user will manipulate the input mechanism when they are looking/have oriented the peripheral device towards the entertainment device outputting the media content, and may look/orient the peripheral device in other directions when not manipulating such mechanisms.

In this case, the input mechanism may be thought of as the sensor which generates a signal in response to user interaction with the media content, this signal also being a control signal for controlling the media content. This signal may then be transmitted from the peripheral device (housing the input mechanism sensor) to the input port of the entertainment device to trigger the comparison between the measured azimuthal angle and the predetermined range.

Hence more generally, the sensor may optionally be an input mechanism of an input device for providing control signals to control the media content. Examples of input mechanisms include buttons, triggers, joysticks, keys, touch pads, touch screens, and the like. It will be appreciated that these examples are entirely non-limiting; the skilled person will understand that other types of input mechanisms are also contemplated within the scope of the present disclosure.

As mentioned previously, examples of input devices include a remote control device (a TV remote, for example), a video game controller, a mouse, a keyboard, a smartphone, a laptop or tablet computer, and a portable video game console. It will be appreciated that these examples are entirely non-limiting; the skilled person will understand that other types of input devices are also contemplated within the scope of the present disclosure.

In embodiments where the to-be-tracked peripheral device includes a head-wearable audio system (headphones, for example), the sensor may be an input mechanism (a button, for example) of an input device that is separate from the head-wearable audio system (a games controller, for example). Alternatively, in embodiments where the to-be-tracked peripheral device includes an input device (a games controller, for example), the sensor may be an input mechanism (a button, for example) of the input device (that is, the to-be-tracked peripheral device).

Alternatively, and as mentioned previously, additional sensors may be employed to detect whether the user’s head/the peripheral device is oriented towards the entertainment device outputting the media content (that is, whether the user is interacting with the media content), and output a signal in response to detecting that the user’s head/the peripheral device is so oriented.

As a non-limiting example, the (additional) sensor may optionally include a light sensing element. Examples of light sensing elements include a photodiode, and a camera. However, these examples are entirely non-limiting; the skilled person will understand that other types of light sensing elements are also contemplated within the scope of the present disclosure.

In embodiments where the to-be-tracked peripheral device includes a head-wearable audio system, the light sensing element may be wearable on the head of the user and configured such that, when in use, the light sensing element senses light from a screen outputting the media content when the face of the user is oriented towards the screen. This is to say that the light sensing element should be positioned on the user’s head such that when the user’s head is directed towards the screen (outputting the media content) the light sensing element may sense the light emitted from the screen. In response to sensing the screen’s light (that is, in response to detecting user interaction with the media content), the light sensing element may generate a signal, and this signal may be transmitted from the light sensing element to the input port of the entertainment device to trigger the comparison between the measured azimuthal angle and the predetermined range.

As will be appreciated, the light sensing element may be a separate hear-wearable item to that of the head-wearable audio system. Alternatively, the light sensing is coupled to the head-wearable audio system. The term “coupled to” here should be taken to mean the light sensing element may be integral with the head-wearable audio system, or attachable thereto.

In embodiments where to-be-tracked peripheral device includes an input device, the light sensing element may be wearable on the hand of the user or coupled to the input device and configured such that, when in use, the light sensing element senses light from a screen outputting the media content when the input device is oriented towards a predefined orientation relative to the screen. This is to say that the light sensing element should be positioned on the user’s hand/the input device such that when the user’s hand (and so the input device) is directed towards a predefined orientation relative to the screen (outputting the media content) the light sensing element may sense the light emitted from the screen. In response to sensing the screen’s light (that is, in response to detecting user interaction with the media content), the light sensing element may generate a signal, and this signal may be transmitted from the light sensing element to the input port of the entertainment device to trigger the comparison between the measured azimuthal angle and the predetermined range.

It should be noted that the predefined orientation may be any orientation that the user finds most appropriate for themselves. Users typically adopt the “towards the screen” orientation as their predefined/preferred orientation — in which case the predefined orientation may coincide with the datum orientation if the latter is also the “towards the screen” orientation. However, other predefined orientations may be used. In any case, the light sensing element should be positioned on the user’s hand/the input device such that when the user’s hand (and so the input device) is directed towards the predefined orientation, the light sensing element adopts the “towards the screen” orientation so as to sense the light emitted from the screen.

In any case, the sensor may transmit the signal to the input port of the entertainment device via wired or wireless communication methods such as a USB/Ethernet ® cable, or Wi-Fi ®/Bluetooth ® communication. As such, receiving step S102 includes receiving the signal from the sensor (at an input of an entertainment device, for example).

### Comparing Azimuthal Angle to Predetermined Range

As mentioned previously, the signal triggers a comparison between the azimuthal angle of the peripheral device (that is, the azimuthal angle of the peripheral device at/proximate to the time at which the signal is received by the entertainment device, for example). As will be appreciated, this comparison is performed to determine whether the IMU’s measurements have been affected by drift.

Therefore, in embodiments of the present disclosure, the method includes the step of, in response to receiving the signal, determining whether a value of the azimuthal angle falls within a predetermined range (step S104). Determining step S104 may be performed by a processing unit (a CPU, GPU, and the like) of the entertainment device (such as a video games console, a computing system, and the like), for example.

As mentioned previously, the predetermined range of values may represent the typical range of azimuthal angle measurements made by the IMU (due to the effect of drift) at a point in time when the peripheral device is assumed/found to be stationary at a predetermined azimuthal angle value (such as a zero-degree angle when the peripheral device is being held in its datum orientation, for example). The point in time in question is that corresponding to when the signal is received by the entertainment device from the sensor. As a corollary, the azimuthal angle should be taken to mean the azimuthal angle of the peripheral device at the point in time in which the sensor signal is received.

If the azimuthal angle measurement falls within the predetermined range of values, then it is assumed that the peripheral device is being held stationary in an orientation aligning with the predetermined azimuthal angle value, and so the azimuthal angle measurement is adjusted to that of the predetermined azimuthal angle value, as will be explained in more detail later herein. Conversely, if the azimuthal angle measurement does not fall within the predetermined range of values, then it may be assumed that the peripheral device is not being held stationary in an orientation aligning with the predetermined azimuthal angle value, and so no adjustment to the azimuthal angle measurement is carried out.

In any case, it will be appreciated that the receiving of the sensor signal triggers the aforementioned comparison. In some embodiments, the sensor signal may only trigger this comparison if the signal satisfies certain criteria. This may be beneficial in the case where the sensor includes a light sensing element, as the light sensing element may detect light from different light sources (light bulbs, smartphone screens, sunlight/streetlight shining through windows, and the like) as its orientation changes during playback of the media content. This light sensing element may output a signal based on the illumination characteristics (brightness/color) of a given light source’s outputted light. For example, the light sensing element may output electrical signals having increasingly higher voltages in response to detecting increasingly brighter light. In this case, it may be preferable to evaluate the signals received from the light sensing element to determine whether a given signal was generated and sent in response to detecting light from the screen outputting the media content. This way, false positive triggering of the aforementioned comparison may be avoided.

Hence more generally, in embodiments of the present disclosure, the method may optionally include the step of evaluating whether the signal (received from the light sensing element) satisfies one or more illumination criteria. In such embodiments, determining step S104 may be carried out if the signal satisfies one or more of the illumination criteria. This evaluating step may be performed by a processing unit (a CPU, GPU, and the like) of the entertainment device (such as a video games console, a computing system, and the like), for example. It should be noted that this evaluating step may be carried out regardless of whether the light sensing element is worn on the user’s head, worn on the user’s hand, or coupled to an input device.

As mentioned previously, this light sensing element may output a signal based on the illumination characteristics of a given light source’s outputted light (outputting electrical signals having increasingly higher voltages in response to detecting increasingly brighter light, for example). As such, the signal voltage (and/or other signal parameter for that matter) may be used as a proxy for the detected light source’s illumination characteristics. Therefore, “illumination criteria” should be taken to mean criteria relating to parameters of the signal sent by the light sensing element, such parameters being proxies for the illumination characteristics of the light source whose light was detected by the light sensing element.

As will be appreciated, the illumination criteria may be defined such that they are satisfied by a signal generated and sent in response to detecting light output from a screen outputting the media content, and not are not satisfied otherwise, for example. In this case, the aforementioned comparison between the azimuthal angle value and the predetermined range may only be triggered in response to a signal satisfying the criteria, that is, a signal generated and sent in response to detecting light output from a screen outputting the media content.

Examples of illumination criteria include a (change in) light color, a (change in) light intensity (also known as brightness), and a frequency range or wavelength range of the light (such as a wavelength range corresponding to infra-red light or visible light, for example). It will be appreciated that these examples are entirely non-limiting; the skilled person will understand that other types of illumination criteria are also contemplated within the scope of the present disclosure. It will also be appreciated that while the examples given explicitly refer to the illumination characteristics of the detected light, these same examples also implicitly relate to parameters of the signal received from the light sensing element given the aforementioned correspondence between the light detected and signal generated by the light sensing element.

To further reduce the chances of false positive comparison triggering, calibration frames may be interspersed amongst image frames of the media content. A calibration frame should be taken to mean an image frame whose image data is such that, when output on a screen, the resulting light output from the screen causes a light sensing element (directed towards the screen) to output a signal which satisfies one or more of the illumination criteria. In this sense, it will be appreciated that a calibration frame helps to calibrate (that is, correct for drift in) the IMU — the light sensing element generates and sends a signal based on the light output from the screen (due to displaying the calibration frame), and the entertainment device finds that this signal satisfies one or more illumination criteria, thus triggering the aforementioned comparison, which may result in the adjusting of the measurements made by of the IMU (that is, the calibration of the IMU).

The image data of such calibration frames may be distinct from the media content’s image frames, resulting in a sharp visual contrast (change in colors/brightnesses/frequencies/wavelengths of light) whenever a calibration frame is output either before or after a given media content image frame. Given that frame rates of displaying media content typically exceed 50 frames per second, such contrasts between media content image frames and calibration frames are typically not detected by users, and so the use of such calibration frames should not interfere with the user’s experience of the media content. However, light sensing elements are able to detect such calibration frames, despite them only being displayed for less than or equal to 0.02 seconds each.

Hence more generally, in embodiments of the present disclosure, the method may optionally include the steps of including the steps of: rendering image frames of the media content; inserting a calibration frame after every N image frames of the media content have been rendered, wherein N ≥ 1, wherein each inserted calibration frame includes predetermined image data for satisfying one or more of the illumination criteria; and outputting the media content having the inserted calibration frames. The rendering and inserting steps may be performed by a processing unit (a CPU, GPU, and the like) of an entertainment device (such as a video games console, a computing system, and the like), for example. The outputting step may be performed by an A/V port (such as an HDMI port, USB port, Ethernet ® port, Wi-Fi ® ports, Bluetooth ® port, and the like) of the entertainment device, optionally in conjunction with a processing unit of the entertainment device. It should be noted that these steps may be carried out regardless of whether the light sensing element is worn on the user’s head, worn on the user’s hand, or coupled to an input device.

The skilled person knows what rendering image frames entails, and so detailed description regarding typical rendering processes will be omitted for brevity’s sake. Regarding the inserting step, the calibration frame may be stored within a buffer within which rendered (that is, to-be-output) image frames (of the media content) are stored, for example. Such a buffer typically stores the image frames in the order in which they are to be output to a display screen, and so in order to insert the calibration frame after every N image frames, each calibration frame is stored within the buffer at a memory location corresponding to the (N+1)^{th}, 2(N+1)^{th}, 3(N+1)^{th}, and so on, frame to be output to the display screen, for example. The skilled person knows what outputting image frames entails, and so detailed description regarding typical displaying processes will be omitted for brevity’s sake

In any case, once it is determined that the azimuthal angle of the IMU does fall within the predetermined range, the azimuthal angle of the IMU may be adjusted so as to correct for the azimuthal drift affect the IMU’s measurements.

### Adjusting the Azimuthal Angle

To improve the IMU’s tracking accuracy, drift correction is performed on the IMU if, at a point in time when the peripheral device is assumed/found to be stationary at a predetermined azimuthal angle value (that is, the point in time corresponding to when the sensor signal is received), the measurement falls within the typical range of azimuthal angle measurements made by the IMU due to the effect of drift. This drift correction involves adjusting the IMU’s measurements to the predetermined azimuthal angle value at which the peripheral device is assumed/found to be oriented, as it is assumed/has been found that peripheral device is so oriented.

Therefore, in embodiments of the present disclosure, the method includes the step of adjusting the azimuthal angle to a predetermined value if the value falls within the predetermined range (step S106). Adjusting step S106 may be performed by a processing unit (a CPU, GPU, and the like) of an entertainment device (such as a video games console, a computing system, and the like) in conjunction with an input port (such as a USB port, Ethernet ® port, Wi-Fi ® port, Bluetooth ® port, and the like) of the entertainment device, for example.

As mentioned previously, the predetermined (azimuthal angle) value is the azimuthal angle towards which the peripheral device is assumed/found to be aligned at the point in time in which the sensor signal is received. This assumption/finding is confirmed when it is found that azimuthal angle measurement falls within the predetermined range of values – the peripheral device is being held in an orientation aligning with the predetermined azimuthal angle value at the time the sensor signal is received. In this case, the azimuthal angle measurement is adjusted to that of the predetermined azimuthal angle value.

Given the assumption that the peripheral device is stationary at the predetermined azimuthal angle value, adjusting the IMU’s azimuthal angle may be carried out by generating (using the processing unit of the entertainment device, for example) a correction signal containing the predetermined azimuthal angle value and a taring/zeroing instruction for taring/zeroing all other azimuthal kinematic properties (such as azimuthal velocity/acceleration/jerk, for example).

In embodiments where the IMU-enabled peripheral device transmits the azimuthal angle to the entertainment device, then the entirety of this correction signal may be transmitted to the IMU-enabled peripheral device (via the input port of the entertainment device, for example). In such embodiments, the correction signal causes the peripheral device/IMU to override the IMU’s measurements such that the azimuthal angle is now the predetermined value, and the azimuthal velocity/acceleration/jerk values are reset to zero (as the peripheral device is assumed to be momentarily stationary).

Alternatively, in embodiments where the IMU-enabled peripheral device transmits measurement data of some other angular kinematic property from which the azimuthal angle may be derived, then the taring/zeroing instruction of the correction signal may be transmitted to the IMU-enabled peripheral device. In such embodiments, the correction signal causes the peripheral device/IMU to override the IMU’s measurements such that the azimuthal velocity/acceleration/jerk values are reset to zero (as the peripheral device is assumed to be momentarily stationary). Meanwhile, the correction signal causes the processing unit of the entertainment device to override its currently determined azimuthal angle value such it is now the predetermined value.

As will be appreciated, sudden adjustments to the azimuthal angle may cause a sudden change in, say, the sound localisation effects provided to the user. Such sudden changes may be jarring to the user. Therefore, it may be beneficial to gradually adjust the azimuthal angle measured by the IMU over a period of time. This way, a smoother change to the sound localisation effects may be provided to the user, reducing/mitigating the impact of sound localisation changes on the user. Hence more generally, adjusting step S106 may include gradually adjusting the azimuthal angle to the predetermined value over a period of time.

### Various Embodiments

As mentioned previously, embodiments of the present disclosure operate under the assumption that the peripheral device is stationary at the predetermined (azimuthal angle) value when the sensor signal is received, this assumption being confirmed when the azimuthal angle value of the IMU (measured at the point in time at which the sensor signal is received) is found to fall within a predetermined range containing the predetermined azimuthal angle value. However, it may be the case that, while the peripheral device’s azimuthal angle value does fall within the predetermined range, the peripheral device may still be moving (and so not stationary) at the time the signal sensor is received. In this case, the azimuthal angle may be adjusted to the predetermined value, potentially causing a taring / zeroing of the azimuthal velocity / acceleration / jerk values even though the actual azimuthal velocity / acceleration/jerk values are non-zero due to the peripheral device’s movement. Thus, the adjustments to the IMU measurements in this case may in itself cause drift to occur.

To address this issue, it may be beneficial to take not only the azimuthal angle value into account, but also azimuthal velocity and/or acceleration. For example, the aforementioned comparison between the azimuthal angle value and the predetermined range may be extended to the azimuthal velocity and/or acceleration values measured by the IMU, such values being compared against respective predetermined ranges to determine whether the IMU/peripheral device is indeed stationary.

As an example, in addition to the aforementioned comparison between the azimuthal angle value and its predetermined range, a predetermined range of azimuthal velocity values may be set as -0.5 m/s to +0.5 m/s. This predetermined range of values may represent the typical range of azimuthal velocity measurements made by the IMU (due to the effect of drift) at a point in time when the peripheral device is assumed/found to be stationary at a predetermined azimuthal angle value, this point in time being when the sensor signal is received. When it is found that the 0.1 m/s measurement made by the IMU falls within this range, the assumption that the peripheral device is stationary is confirmed, and so the azimuthal angle may be adjusted to the predetermined azimuthal angle value (zero degrees, in this case). This comparison process may similarly be applied to azimuthal acceleration values, alternatively or in addition to its application to azimuthal velocity values. In any case, the adjustment of the azimuthal angle may therefore be carried out when it has been determined that the peripheral device is indeed stationary, thereby reducing the frequency/likelihood/extent of drift being paradoxically causing by way of this drift correction.

Hence more generally, in embodiments of the present disclosure, obtaining step S100 may include obtaining an azimuthal velocity and/or azimuthal acceleration from the IMU; determining step S104 may include, in response to receiving the signal, determining whether a azimuthal velocity value and/or azimuthal acceleration value falls within a predetermined velocity range and/or a predetermined acceleration range; and adjusting step S106 may be carried out if the azimuthal velocity value and/or azimuthal acceleration value falls within the predetermined velocity range and/or the predetermined acceleration range.

As mentioned previously, the azimuthal angle value obtained from the IMU may be measured with respect to some datum orientation of the peripheral device. As mentioned previously, this datum orientation should be taken to mean an orientation relative to which any angular (azimuthal, for example) displacements of the peripheral device are measured by the IMU, with zero-degree azimuthal/angular displacement being measured in the case where the peripheral device is oriented in the datum orientation. This datum orientation may be any orientation of the peripheral device relative to the entertainment device outputting the media content, with the most commonly-used datum orientation being a “towards the screen” orientation (yet other orientations may be set as the datum orientation).

As mentioned previously, this datum orientation may represent the orientation in which the user most frequently/commonly holds/wears their peripheral device. As such, it may be beneficial to set the predetermined azimuthal angle value (to which the IMU’s measurements is adjusted if drift correction is to be applied to the IMU) such that it coincides with the datum orientation — the user is likely to return to holding the peripheral device stationary at a zero-degree angle (that is, the datum orientation) after moving the peripheral device around (when talking to friends, looking at smartphones screens, or the like).

However, if the datum orientation is viewed as being the most-commonly adopted orientation by the user, then this datum orientation may change during playback of the media content, as the user may change their posture/pose over time. This is especially apparent in the case of video gaming sessions, in which may last up to several hours each for some users.

In such case, it may be beneficial to track the change in the datum orientation over time so as to provide more accurate drift correction. For example, if the most-commonly adopted peripheral device orientation changes (due to the user’s posture changing, for example) but the datum orientation and predetermined azimuthal angle value have not been updated, then in response to a sensor signal being received, the azimuthal angle (measured with respect to the now-inaccurate datum orientation) may be found to not fall within the predetermined range, even though the peripheral device is currently stationary in the new most-commonly adopted orientation. This would lead to drift correction not being applied, thus compounding measurement errors over time.

To provide such datum orientation tracking, sensor signals may be used to trigger azimuthal angle measurements to be taken (as has been discussed earlier herein). However, regardless of whether a given measurement falls within the predetermined range, the given measurement may be stored (in a storage unit of the entertainment device, for example). Subsequently, an average azimuthal angle value may be calculated/determined using the resulting stored plurality of azimuthal angle values, and this average value may be used to adjust the datum orientation.

As a non-limiting working example, at the start of a video gaming session, the datum orientation may be set as a “towards the screen” orientation. During a first period of time in the gaming session (say, the first 30 minutes of gameplay), a first plurality of sensor signals are received by the entertainment device (in response to a plurality of user manipulations of the game controller’s input mechanisms, for example). For each sensor signal of this first plurality of sensor signals, the corresponding azimuthal angle value measured by the IMU is stored, and the average value may (re)calculated each time a new azimuthal angle is stored, each (re)calculation being based on all the stored values, for example. It may be found over the course of this first period of time that the average value does not deviate significantly from “towards the screen” datum orientation, that is, the average value is consistently found to be at/near zero degrees. In this case, no update to the datum orientation may be carried, as the “towards the screen” orientation has been found to be fulfilling the role of datum (most-commonly adopted) orientation.

However, at the start of a second time period of the gaming session (say, the subsequent 30 minutes of gameplay), the user changes their posture and continues to manipulate the game controller’s input mechanisms to play the game. In response to the manipulations of the input mechanisms, a second plurality of sensor signals are received by the entertainment device. For each sensor signal of this second plurality of sensor signals, the corresponding azimuthal angle value measured by the IMU is stored. As before, the average value may (re)calculated each time a new azimuthal angle is stored, each (re)calculation being based on all the stored values, for example. However, over the course of the second time period, the average value gradually changes from at/near zero degrees towards, say, +10 degrees due to the change in posture of the user. In this case, the datum orientation may be adjusted to the average azimuthal angle value of +10 degrees so that future measurements are made with respect to this new datum. As a corollary, azimuthal angle values measured after the datum orientation adjustment will be 10 degrees less than if the datum orientation adjustment had never occurred, with the average value of 10 degrees effectively being tared/zeroed. As the predetermined azimuthal angle value and the predetermined range are defined with respect to the datum orientation, any adjustment to the datum orientation results in a de facto adjustment to the predetermined azimuthal angle value and the predetermined range. For example, the predetermined range may still be -3 degrees to +3 degrees with respect to the datum orientation, and the predetermined azimuthal angel value may still be zero degrees with respect to the datum orientation, yet the datum orientation’s value has changed.

As will be appreciated the aforementioned datum orientation tracking is carried out under the assumption that the averaging of the stored values may reduce the effect of drift affecting the measurement accuracy of the stored values. For example, drift may result in some stored values being overestimations of the azimuthal angle and some stored values being underestimations of the azimuthal angle, yet the nature of averaging may help to reduce the extents of overestimation/underestimate, yielding a more accurate average value.

In any case, and more generally, in embodiments of the present disclosure, the value of the azimuthal angle, the predetermined range and the predetermined value may all be defined with respect to a datum orientation of the peripheral device, and the method may optionally include the steps of: receiving a plurality of signals from the sensor, each signal being generated in response to a respective user interaction with the media content; for each signal that is received, storing a respective instantaneous value of the azimuthal angle, regardless of whether the respective instantaneous value falls within the predetermined range; determining an average value of the azimuthal angle based on the stored respective instantaneous values; and adjusting the datum orientation of the peripheral device based on the average value.

The step of receiving the plurality of signals may be performed by an input port (such as a USB port, Ethernet ® port, Wi-Fi ® port, Bluetooth ® port, and the like) of an entertainment device (such as a video games console, a computing system, and the like), for example. As will be appreciated, the step of receiving the plurality of signals is similar to that of receiving step S102. As such, the discussion provided earlier with respect to receiving step S102 may apply to this step of receiving the plurality of signals, mutatis mutandis.

The step of storing a respective instantaneous value (for each received signal) may be performed by a memory (such as a RAM, a ROM, and the like) of an entertainment device (such as a video games console, a computing system, and the like), optionally in conjunction with a processing unit thereof (such as a CPU, a GPU, and the like), for example.

The step of determining an average value may be performed by a processing unit (a CPU, GPU, and the like) of the entertainment device (such as a video games console, a computing system, and the like), for example.

The step of adjusting the datum orientation may be performed by a processing unit (a CPU, GPU, and the like) of an entertainment device (such as a video games console, a computing system, and the like) in conjunction with an input port (such as a USB port, Ethernet ® port, Wi-Fi ® port, Bluetooth ® port, and the like) of the entertainment device, for example. As will be appreciated, the step of adjusting the datum orientation is similar to that of adjusting step S106. As such, the discussion provided earlier with respect to receiving step S106 may apply to this step of adjusting the datum orientation, mutatis mutandis.

As will be appreciated, in the above example, the average value gradually changes due to taking into account all stored values for each recalculation of the average value. This gradual change may increase the lag time between the user changing their posture/most-commonly adopted peripheral device orientation and the datum orientation being adjusted to reflect such change. As will be appreciated, the peripheral device motion/position tracking taking place with this period of lag may result in inaccurate sound localisation/game interactions, leading to poorer user experience and potentially even nausea due to positional misalignment between in-game objects and their associated sounds.

In this case, it may be beneficial to determine a respective average value for successive predetermined periods of time during playback of the media content. Turning back to the above example, a first average value may be determined using the values stored during the first period of time (first 30 minutes, for example) of the video gaming session, and a second average value may be determined using the values stored during the second period of time (the subsequent 30 minutes, for example) without using the values stored during the first period of time (as was the case in the above example). This way, the lag time between changes in the user’s posture/most-commonly adopted peripheral device orientation and the resulting datum orientation change may be reduced, as there is less historical data being used for determining (and therefore skewing) the average value.

As will be appreciated, in order to determine the respective period of time in which each stored value was measured, each value may be stored along with a corresponding timestamp indicating the time at which the value was measured.

Hence optionally, the step of storing the respective instantaneous value includes storing the respective capture time (timestamp, for example) at which the respective instantaneous value was measured (by the IMU), and the step of determining the average value includes: selecting the stored instantaneous values whose respective capture times fall within a predetermined time period, the predetermined time period corresponding to a present real-world time; and determining the average value based on the selected values.

To illustrate the selecting step by way of non-limiting example, if a video gaming session may be subdivided into 30-minute-long time periods (such as a first 30 minutes of the session, and a subsequent 30 minutes of the session, and so on), and if 45 minutes the video gaming session has lapsed with respect to present real-world time, then any stored values having measurement times falling within the first 30 minute time period are not selected, yet any stored values having measurement times falling within the subsequent 30 minute time period are selected. This is because the first 30 minute time period no longer corresponds to the present real-world 45 minutes from the start of the session (this time period is deemed historical data which may skew further averages), yet the subsequent 30 minute time period does correspond to the present real-world 45 minutes from session start (that is, 45 minutes falls between 30 minutes and 60 minutes).

Notably, this concept of averaging historical azimuth angle data may be extended to the drift correction method itself to prevent false positive triggering of the comparison between an azimuth angle value and the predetermined range in yet another scenario.

Consider a scenario in which a user wearing a pair of IMU-enabled headphones is looking at a display screen displaying media content. During playback of the media content, the orientation of the user’s head may change but remain within the predetermined range. For example, the predetermined range may be between -3 and +3 degrees (relative to a “towards the screen” orientation”), and the user’s head orientation changes from say 0 degrees (that is, looking at the centre of the screen) to -1 degrees (that is, looking towards the left side of the screen). In this case, when the sensor sends a signal indicating user interaction with the media content, a false positive triggering of the comparison between azimuthal angle value and the predetermined range may occur, and the IMU of the headphones may be tared/zeroed. As a result, the sound localisation effects provided to the user may be inaccurate, as they are defined relative to an assumed “looking at the centre of the screen” orientation rather than the actual “looking at the left side of the screen” orientation.

To address this issue, the drift correction may instead be carried out if the average azimuthal value over the past, say, 30 seconds is found to fall within the predetermined range. For example, the predetermined range may be a range of absolute values (that is, magnitudes) of the azimuth angle, say, a magnitude between 1 and 3 degrees. In this case, when the sensor sends a signal indicative of user interaction with the media content, the average value of the azimuth angle over the past 30 seconds may be determined as, say, -1.5 degrees, and this average value may be compared with the predetermined range. Given that the magnitude of this average value falls within the predetermined range of 1 to 3 degrees, the IMU of the headphones may be tared/zeroed.

Hence more generally, in embodiments of the present disclosure, obtaining step S100 may include obtaining a time-series data stream of the azimuthal angle of the peripheral device; the method may include a step of storing the obtained time-series data stream, and determining step S104 may include, in response to receiving the signal, selecting a subset of the stored time-series data stream, an endpoint of the subset being a present real-world time (that is, the subset may be, say, the most recent 30 seconds), and determining an average value of the azimuthal angle based on the selected subset; and adjusting step S106 may include adjusting a most-recently obtained value of the azimuthal angle to a predetermined value if the average value falls within the predetermined range.

### Computer Program and Storage Medium

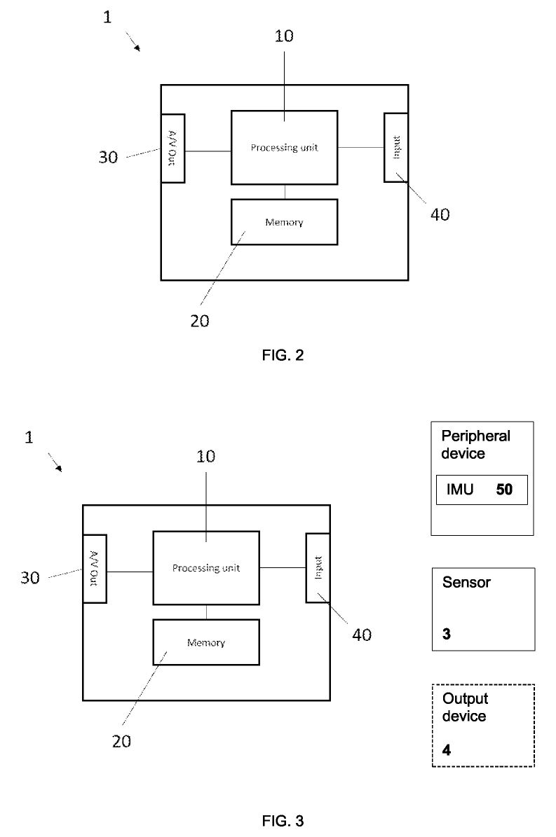

It will be appreciated that the above methods may be carried out on conventional hardware (such as computing system 1 of FIG. 2) suitably adapted as applicable by software instruction or by the inclusion or substitution of dedicated hardware.

Thus the adaptation to existing parts of a conventional equivalent device may be implemented in the form of a computer program product including processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

### Device and System

In embodiments of the present disclosure, a device for correcting azimuthal drift arising in an inertial measurement unit, IMU, of a peripheral device operable by a user includes a processor and a memory, the memory having stored thereon processor-implementable instructions which, when executed by the processor, cause the processor to perform embodiments of the above-described method.

Turning now to FIG. 2, as an example embodiment of the present disclosure, the device may be computing system 1. The circuitry of computing system 1 may include the following components listed in turn below.

Computing system 1 may include processing unit 10. Processing unit 10 may be a central processing unit (CPU) and/or a graphical processing unit (GPU). The CPU may be a single or multi core processor. The GPU may be physically separate to the CPU, or may be integrated with the CPU as a system on a chip (SoC). Processing unit 10 may be configured to execute processor-implementable instructions which cause it to carry out embodiments of the above-described method.

Computing system 1 may include memory 20. Memory 20 may be a RAM, ROM, and/or the like. The RAM may be physically separate to the CPU and/GPU, or may be integrated therewith as part of an SoC. Alternatively or in addition, memory 20 may be an external or internal hard drive, or an external or internal solid state drive. Memory 20 may be configured to store the processor-implementable instructions.

Computing system 1 may include A/V output port 30. A/V output port 30 may enable computing system 1 to transmit audio/visual outputs to one or more other devices/systems. Examples of A/V output port 30 include HDMI ports, USB ports, Ethernet ® ports, Wi-Fi ® ports, Bluetooth ® ports, and the like.

Computing system 1 may include input port 40. Input port 40 may enable computing system 1 to receive data from one or more other devices/systems. Examples of Input port 40 include USB ports, Ethernet ® ports, Wi-Fi ® ports, Bluetooth ® ports, and the like.

Where components of computing system 1 are not integrated, such components may be connected either by a dedicated data link or via an I/O bus.

It will be apparent to a person skilled in the art that variations in the operations of the above device corresponding to the various embodiments of the computer-implemented method as described and claimed herein are considered within the scope of the present disclosure.

Turning now to FIG. 3, in embodiments of the present disclosure, a system for correcting azimuthal drift arising in an inertial measurement unit, IMU, of a peripheral device operable by a user includes the above-described device (such as computing system 1), peripheral device 2 including the IMU 50, and sensor 3 configured to generate a signal in response to user interaction with the media content.

Optionally, the system may include output device 4 (such as a display screen or speaker system) for outputting the media content (such as a film, video game, music, or the like).

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A method of correcting azimuthal drift arising in an inertial measurement unit, IMU, of a peripheral device operable by a user, the method comprising:
obtaining, from the IMU, an azimuthal angle of the peripheral device;
receiving a signal from a sensor, the signal being generated by the sensor in response to user interaction with media content;
in response to receiving the signal, determining whether a value of the azimuthal angle falls within a predetermined range; and
adjusting the azimuthal angle to a predetermined value if the value falls within the predetermined range.

2. The method of claim 1, wherein the peripheral device comprises a head-wearable audio system.

3. The method of claim 2, wherein the head-wearable audio system is one of:
i. a pair of headphones;
ii. a pair of bone conduction headphones; and
iii. a pair of earphones.

4. The method of claim 2, wherein the sensor is an input mechanism of an input device for providing control signals to control the media content.

5. The method of claim 4, wherein the input device is one of:
i. a remote control device;
ii. a video game controller;
iii. a mouse;
iv. a keyboard;
v. a smartphone;
vi. a laptop or tablet computer; and
vii. a portable video game console.

6. The method of claim 2, wherein the sensor comprises a light sensing element wearable on the head of the user and configured such that, when in use, the light sensing element senses light from a screen outputting the media content when a face of the user is oriented towards the screen.

7. The method of claim 6, wherein the light sensing element is coupled to the head-wearable audio system.

8. The method of claim 6, wherein the lighting sensing element comprises one or more of:
i. a photodiode;and
ii. a camera.

9. The method of claim 6, further comprising:
evaluating whether the signal satisfies one or more illumination criteria, wherein determining whether the value of the azimuthal angle falls within a predetermined range is carried out if the signal satisfies one or more of the illumination criteria.

10. The method of claim 9, wherein the one or more illumination criteria comprise one or more of:
i. a light color;
ii. a light intensity;
iii. a change in light color;
iv. a change in light intensity; and
v. a frequency range or wavelength range of the light.

11. The method of claim 9, further comprising:
rendering image frames of the media content;
inserting a calibration frame after every N image frames of the media content have been rendered, wherein N ≥ 1, wherein each inserted calibration frame comprises predetermined image data for satisfying one or more of the illumination criteria; and
outputting the media content having the inserted calibration frames.

12. The method of claim 1, wherein the peripheral device comprises an input device for providing control signals to control the media content.

13. The method of claim 12, wherein the sensor is an input mechanism of the input device.

14. The method of claim 12, wherein the sensor comprises a light sensing element wearable on a hand of the user or coupled to the input device and configured such that, when in use, the light sensing element senses light from a screen outputting the media content when the input device is oriented towards a predefined orientation relative to the screen.

15. The method of claim 14, further comprising evaluating whether the signal satisfies one or more illumination criteria, wherein the step of determining whether the azimuthal angle falls within a predetermined range is carried out if the signal satisfies one or more of the illumination criteria.

16. The method of claim 15, further comprising:
rendering image frames of the media content;
inserting a calibration frame after every N image frames of the media content have been rendered, wherein N ≥ 1, wherein each inserted calibration frame comprises predetermined image data for satisfying one or more of the illumination criteria; and
outputting the media content having the inserted calibration frames.

17. The method of claim 1, wherein:
obtaining an azimuthal angle comprises obtaining an azimuthal velocity and/or azimuthal acceleration from the IMU;
determining whether the value of the azimuthal angle falls within the predetermined range comprises, in response to receiving the signal, determining whether a azimuthal velocity value and/or azimuthal acceleration value falls within a predetermined velocity range and/or a predetermined acceleration range; and
adjusting the azimuthal angle is carried out if the azimuthal velocity value and/or azimuthal acceleration value falls within the predetermined velocity range and/or the predetermined acceleration range, respectively.

18. The method of claim 1, wherein the value of the azimuthal angle, the predetermined range and the predetermined value are all defined with respect to a datum orientation of the peripheral device, further comprising:
receiving a plurality of signals from the sensor, each signal being generated in response to a respective user interaction with the media content;
for each signal that is received, storing a respective instantaneous value of the azimuthal angle, regardless of whether the respective instantaneous value falls within the predetermined range;
determining an average value of the azimuthal angle based on the stored respective instantaneous values; and
adjusting the datum orientation of the peripheral device based on the average value.

19. The method of claim 18, wherein storing the respective value comprises storing the respective capture time at which the respective value was measured, and determining the average value comprises:
selecting the stored instantaneous values whose respective capture times fall within a predetermined time period, the predetermined time period corresponding to a present real-world time; and
determining the average value based on the selected instantaneous values.

20. The method of claim 1, wherein:
the obtaining comprises obtaining a time-series data stream of the azimuthal angle of the peripheral device;
the method further comprises storing the obtained time-series data stream;
the determining comprises:
in response to receiving the signal, selecting a subset of the stored time-series data stream, an endpoint of the subset being a present real-world time, and
an average value of the azimuthal angle based on the selected subset; and
the adjusting comprises adjusting a most-recently obtained value of the azimuthal angle to a predetermined value if the average value falls within the predetermined range.

21. A system, comprising:
a peripheral device comprising an inertial measurement unit, IMU;
a sensor configured to generate a signal in response to user interaction with the media content; and
one or more computers and one or more storage devices storing instructions that are operable, when executed by the one or more computers, to cause the one or more computers to perform operations comprising:
obtaining, from the IMU, an azimuthal angle of the peripheral device; receiving a signal from a sensor, the signal being generated by the sensor in response to user interaction with media content;
in response to receiving the signal, determining whether a value of the azimuthal angle falls within a predetermined range; and
adjusting the azimuthal angle to a predetermined value if the value falls within the predetermined range.

22. The system of claim 21, comprising an output device for outputting the media content.

23. One or more non-transitory computer storage media encoded with computer program instructions that when executed by one or more computers cause the one or more computers to perform operations for correcting azimuthal drift arising in an inertial measurement unit, IMU, of a peripheral device operable by a user, the operations comprising:
obtaining, from the IMU, an azimuthal angle of the peripheral device; receiving a signal from a sensor, the signal being generated by the sensor in response to user interaction with media content;
in response to receiving the signal, determining whether a value of the azimuthal angle falls within a predetermined range; and
adjusting the azimuthal angle to a predetermined value if the value falls within the predetermined range.
